(19) United States
(12) Patent Application Publication
(10) Pub. No.: US 2006/0264284 A1
(43) Pub. Date: Nov. 23, 2006

(54) VEHICLE

(75) Inventor: Yasuhiro IWAKI, Iwata-shi, Shizuoka-ken (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(73) Assignee: Yamaha Hatsudoki Kabushiki Kaisha, Iwata-shi (JP)

(21) Appl. No.: 11/380,362

(22) Filed: Apr. 26, 2006

(30) Foreign Application Priority Data
Apr. 26, 2005 (JP) 2005-127578

(51) Int. Cl. F16H 7/18

(52) U.S. Cl. 474/140

(57) ABSTRACT

A vehicle has an engine case that is prevented from being broken and a chain guide that is prevented from breaking even when an external force of a magnitude exceeding a prescribed value is applied to the chain guide. The chain guide has a lower mounting portion and an upper mounting portion that are mounted to a transmission case. The upper mounting portion has a mounting hole having an elongate hole configuration. Convex portions (guide-side stopper), which are provided in the mounting hole of the chain guide, and a mounting bolt of an engine (engine-side stopper) abut each other. When an external force of a magnitude equal to or higher than a prescribed value is exerted on the chain guide, the convex portions undergo deformation, whereby the chain guide moves in the direction corresponding to a direction of application of the external force.

### BACKGROUND OF THE INVENTION

1. Field of the Invention

The present invention relates to a vehicle in which the power of an engine is transmitted to a drive wheel by coupling a drive sprocket, which is mounted to an output shaft of the engine, and a driven sprocket, which is mounted to an axle of the drive wheel, to each other with a transmission chain, and more specifically, to an improvement of a chain guide arranged in the drive sprocket.

2. Background of the Invention

In vehicles such as a motorcycle and a compact all-terrain four-wheel drive vehicle, a drive sprocket mounted to an output shaft of an engine and a driven sprocket mounted to an axle of a rear wheel are coupled to each other by a transmission chain to transmit the power of the engine to the rear wheel, thereby running the vehicle.

In those vehicles, in order to prevent the transmission chain from skipping or dislodging from the drive sprocket, the chain guide is arranged on the side of the drive sprocket opposite to the driven sprocket.

Further, JP-U-Sho 57-24620, for example, proposes a design in which the lower end portion of a chain guide is fixed to an engine case with a bolt, an elongate hole allowing the chain guide to pivot about the bolt in the lower end portion is formed in the upper end portion thereof, and the bolt is inserted through the elongate hole for fixation to the engine case, thereby adjusting the gap between the chain guide and a drive sprocket.

Incidentally, when a stone or the like thrown up by a running vehicle is wedged in between the transmission chain and the drive sprocket, the roller of the transmission chain rides over the tip of the teeth of the sprocket, and the portion thus riding over the teeth tip causes an excessive external force to act on the chain guide, which may, in extreme cases, cause breakage of the engine case supporting the chain guide.

A conceivable way to avoid such breakage of the engine case is to move the chain guide along an elongate hole at the time when the external force is applied. However, according to the conventional structure described above, the chain guide is retained in place by the friction force due to the fastening action using bolts. Since it is difficult to control the magnitude of this friction force, when the conventional structure is adopted as it is, there is a possibility that variations may occur in the retention force to be exerted against the movement of the chain guide due to the external force or, depending on the case, the fixation at the upper end portion of the chain guide is broken off to cause the chain guide to thrash or the chain guide is sucked in between the drive sprocket and the transmission chain. Further, depending on the way the gap between the chain guide and the chain is adjusted, the bolt may be located in the rear portion of the elongate hole of the chain guide. When the external force is exerted in this state, the rear edge of the elongate hole of the chain guide is broken, and the chain guide moves out of the fixation, which may cause such problems as thrashing and sucking of the chain guide.

### SUMMARY OF THE INVENTION

In order to overcome the problems described above, preferred embodiments of the present invention provide a vehicle that makes it possible to prevent an engine case from being broken or a chain guide from breaking when an excessive external force is applied to the chain guide.

A preferred embodiment of the present invention provides a vehicle including a drive sprocket mounted to an output shaft of an engine, a driven sprocket mounted to an axle of a drive wheel, a transmission chain for coupling the driven sprocket and the drive sprocket to each other, and a chain guide arranged on a side of the drive sprocket opposite to the driven sprocket, wherein the chain guide has a lower mounting portion and an upper mounting portion that are mounted to the engine by a mounting member, the upper mounting portion has a mounting hole having an elongate hole configuration through which the mounting member passes, a guide-side stopper disposed in the chain guide and an engine-side stopper disposed in the engine abut each other, and when an external force of a magnitude equal to or higher than a prescribed value is exerted on the chain guide, the guide-side stopper undergoes deformation, causing the chain guide to move in a direction corresponding to a direction of application of the external force.

Here, according to a preferred embodiment of the present invention, the time when an external force of a magnitude equal to or higher than a prescribed value is exerted, refers to the case where, for example, the roller of the transmission chain rides over the teeth of the sprocket or the case where the transmission chain breaks or becomes dislodged so as to be caught in between the chain guide and the drive sprocket.

With the vehicle according to various preferred embodiments of the present invention, when the external force having a magnitude equal to or higher than the prescribed value is exerted on the chain guide, the guide-side stopper undergoes deformation so as to allow the movement of the chain guide, whereby there is no possibility for the engine-side stopper to be broken. That is, the breakage of the engine case can be prevented even when the external force of the magnitude equal to or higher than the prescribed value is exerted on the chain guide.

According to various preferred embodiments of the present invention, since the movement of the chain guide is permitted through deformation of the guide-side stopper of the chain guide, the magnitude of the external force when the chain guide moves can be set based on the strength of the guide-side stopper or the like, thereby eliminating the problem in which the magnitude of the external force depends on the fastening force exerted by the mounting bolt.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a side view of an all-terrain vehicle according to a first preferred embodiment of the present invention.

FIG. 2 is a rear view of the all-terrain vehicle of FIG. 1.

FIG. 3 is a side view of an engine unit of the all-terrain vehicle of FIG. 1.

FIG. 4 is a side view of the engine unit in which a chain guide is disposed.

FIG. 5 is a sectional view of the engine unit as seen from the bottom.

FIG. 6 is a partial sectional view of the engine unit as seen in plan view.

FIG. 7 is a side view of the chain guide.

FIG. 8 is a side view of the chain guide.

FIG. 9 is a side view of stoppers of the chain guide according to a second preferred embodiment of the present invention.

FIG. 10 is a side view of stoppers of the chain guide according to a third preferred embodiment of the present invention.

### DETAILED DESCRIPTION OF PREFERRED EMBODIMENTS

Hereinbelow, preferred embodiments of the present invention will be described with reference to the accompanying drawings.

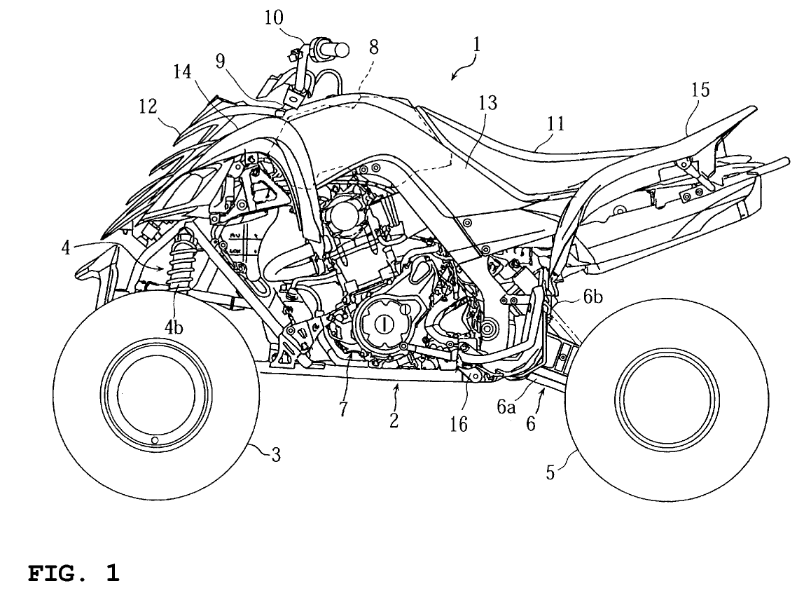

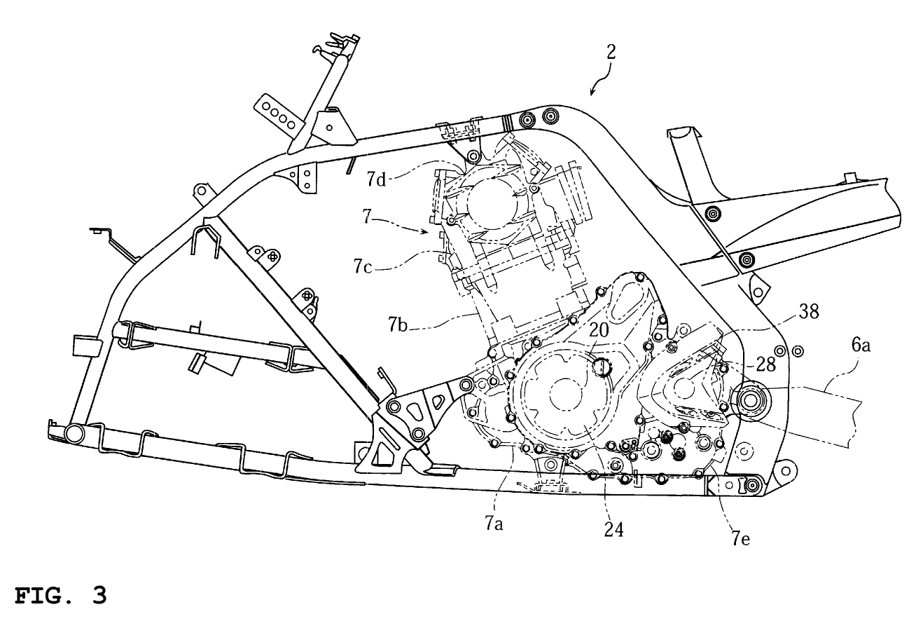

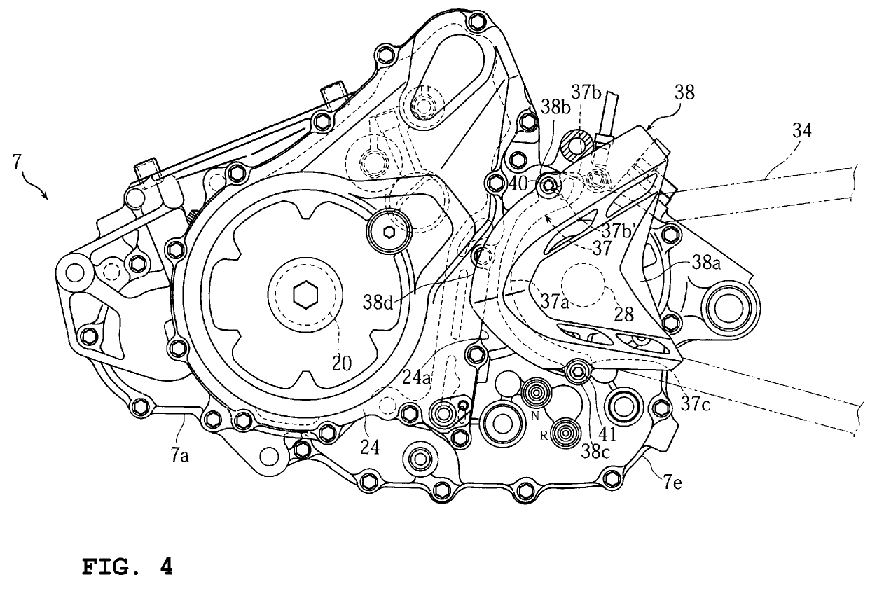

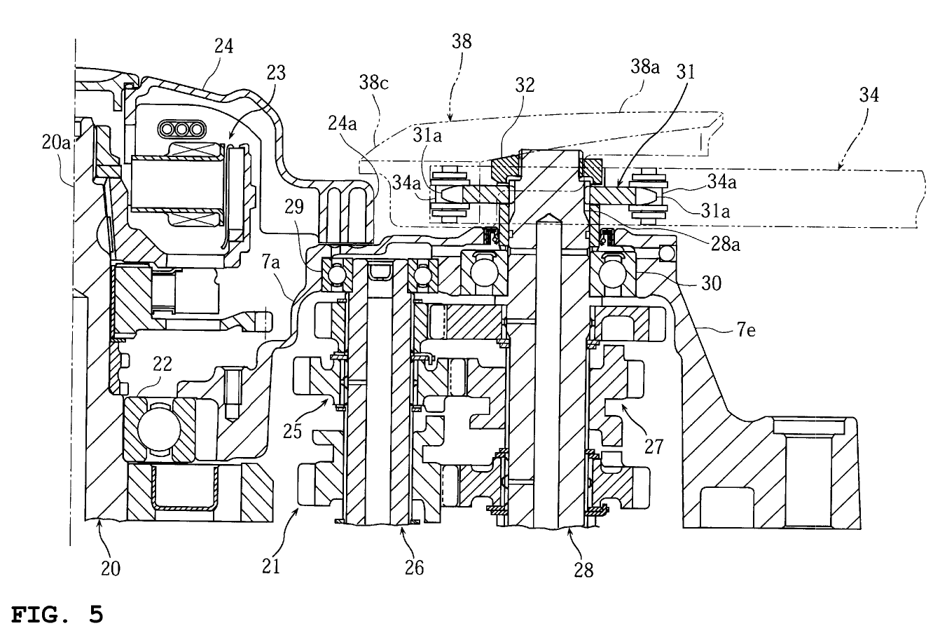

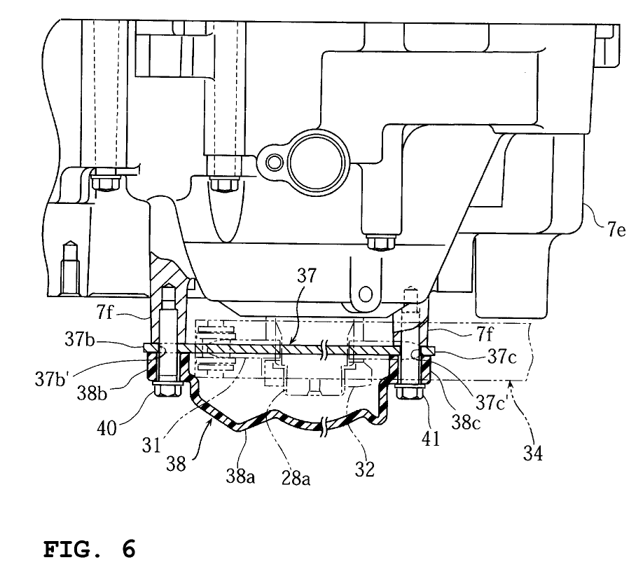

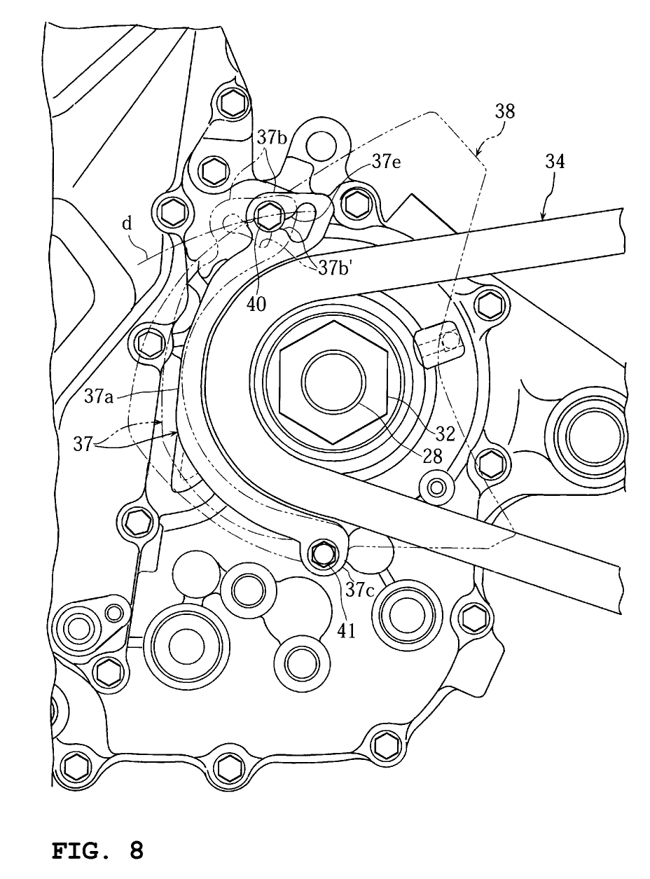

FIGS. 1 to 8 are views illustrating an all-terrain vehicle according to a first preferred embodiment of the present invention. It should be noted that the words “front”, “rear”, “right”, and “left” used in the description of this preferred embodiment refer to the front, rear, right, and left when viewed by the driver sitting on the seat.

Referring to the figures, reference numeral 1 denotes an all-terrain vehicle, and the vehicle 1 has a general construction as described below. On the left and right sides of the front end portion of a double cradle type vehicle body frame 2, left and right front wheels 3, 3 with low-pressure, wide balloon tires are supported in a vertically swingable manner through left and right front wheel suspension devices 4, 4, and at the rear end portion thereof, left and right rear wheels 5, 5 similar to the front wheels are supported in a vertically swingable manner through a rear wheel suspension device 6.

Further, an engine unit 7 is mounted within the cradle of the vehicle body frame 2, with a fuel tank 8 being mounted above the engine unit 7. Further, a steering shaft 9 for steering the left and right front wheels 3, 3 is disposed forward of the fuel tank 8 so as to be laterally pivotable, with a steering handle 10 being fixed to the upper end of the steering shaft 9.

A seat 11 is disposed rearward of the fuel tank 8, and a foot rest 16 is attached at each of the lower left and right end portions of the vehicle body frame 2 below the seat 11. Further, the portion extending forward of the steering shaft 9 is covered with a front cover 12, and the left and right lateral surfaces of the fuel tank 8 and the lower left and right sides of the seat 11 are covered with a side cover 13. Furthermore, left and right front fenders 14, 14, and left and right rear fenders 15, 15 are disposed above the left and right front wheels 3, 3 and the left and right rear wheels 5, 5, respectively.

The left and right front wheel suspension devices 4 have a structure in which the front wheel 3 is supported by upper and lower front arms (not shown), which are supported on the front portion of the vehicle body frame 2 so as to be vertically swingable, with a cushion unit 4b being interposed between the lower front arm and the vehicle body frame 2.

The rear wheel suspension device 6 has a structure in which the rear wheel 5 is supported by a rear arm 6a, which is supported on the rear portion of the vehicle body frame 2 so as to be vertically swingable, with a cushion unit 6b being interposed between the rear arm 6a and the vehicle body frame 2 so as to be located approximately at the center with respect to the vehicle width direction.

The general construction of the engine unit 7 is such that a transmission case 7e with a built-in transmission mechanism 21 is integrally formed in the rear portion of a crankcase 7a accommodating a crankshaft 20, and a cylinder block 7b, a cylinder head 7c, and a head cover 7d are arranged in a stacked manner on the upper wall of the front portion of the crankcase 7a and joined together preferably by fastening with bolts, although other fastening elements could be used. It should be noted that the crankcase 7a and the transmission case 7e are preferably a laterally split type.

The crankshaft 20 is arranged so as to extend in the vehicle width direction, and is supported on the crankcase 7a through a bearing 22. Further, a generator 23 is mounted to a left-side end portion 20a of the crankshaft 20 which extends outwards from the crankcase 7a. The generator 23 is covered with a crankcase cover 24 bolted onto the crankcase 7a.

The transmission mechanism 21, which is arranged substantially parallel to the crankshaft 20, has a structure in which an intermediate shaft 26 to which a transmission gear group 25 is mounted, and an output shaft 28, to which a counter gear group 27 in mesh with the transmission gear group 25 is mounted, are supported by the transmission case 7e through bearings 29, 30, respectively.

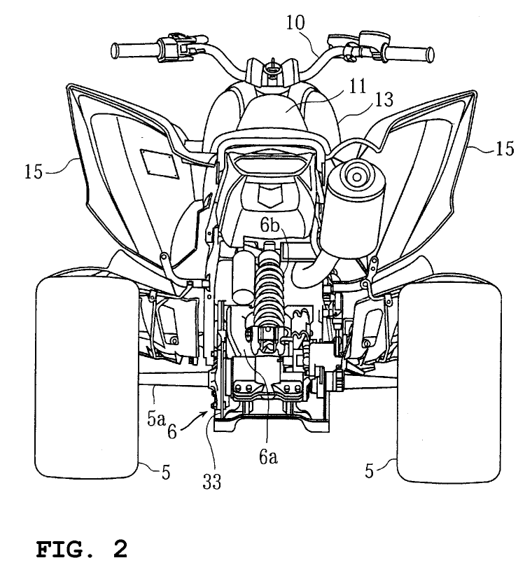

A left-side end portion 28a of the output shaft 28 projects outwardly from the transmission case 7e, with a drive sprocket 31 being fixed to the left-side end portion 28a preferably by a locknut 32. Further, a driven sprocket 33 (see FIG. 2) is mounted to an axle 5a of the rear wheel 5, the driven sprocket 33 and the drive sprocket 31 being coupled to each other by a transmission chain 34. A vertical rear wall 24a of the crankcase cover 24 covers the portion in front of the drive sprocket 31.

A chain guide 37 preferably made of sheet metal is arranged on the side in front of the drive sprocket 31 (the side opposite to the driven sprocket). Further, a sprocket cover 38 preferably made of resin is arranged on the outer side with respect to the vehicle width direction of the drive sprocket 31.

The sprocket cover 38, which also functions as an exterior part, has a cover body 38a, preferably having a generally triangular shape as seen from the lateral side of the vehicle, and a pair of upper and lower mounting boss portions 38b, 38c provided in the cover body 38a. The cover body 38a covers the drive sprocket 31, and the chain guide 37, and a front end portion 38d of the cover body 38a extends so as to be located forward of the vertical rear wall 24a of the crankcase cover 24.

The chain guide 37 has a substantially arcuate guide plate portion 37a arranged so as to surround the front half portion of the drive sprocket 31 around which the transmission chain 34 is wound, and an upper mounting portion 37b and a lower mounting portion 37c that are integrally formed at the upper and lower ends of the guide plate portion 37a, respectively. The upper mounting portion 37b, and the lower mounting portion 37c have mounting holes 37b′, 37c′, respectively.

Upper and lower mounting boss portions 7f, 7f are integrally formed on the upper side of the transmission case 7e at portions corresponding to the upper and lower mounting portions 37b, 37c.

Mounting bolts 40, 41 are inserted from outside into the boss portions 38b, 38c of the sprocket cover 38 and into the mounting holes 37b′, 37c′ of the chain guide 37, respectively. By screwing the mounting bolts 40, 41 into the mounting boss portions 7f, 7f, the sprocket cover 38 and the chain guide 37 are fastened onto the transmission case 7e together.

A slight gap is formed between the inner peripheral surface of the guide plate portion 37a of the chain guide 37 and the transmission chain 34, and a gap(s) of a size permitting the forward movement of the chain guide 37, which will be described later, is formed between the outer peripheral surface of the guide plate portion 37a and the vertical rear wall portion 24a of the crankcase cover 24.

The mounting hole 37b′ of the upper mounting portion 37b is preferably has an elongated hole configuration that permits the forward pivotal movement of the chain guide 37 about the lower mounting portion 37c. Further, the mounting hole 37′ has a generally triangular shape whose left and right oblique sides are formed by an external force direction portion (b), which is substantially formed in conformity with a direction (c) of application of an external force, and a pivotal movement direction portion (a), which is substantially formed in conformity with a circular arc (d) drawn around the lower mounting portion 37c. The mounting bolt 40 is inserted so as to be located at the apex portion of the triangle.

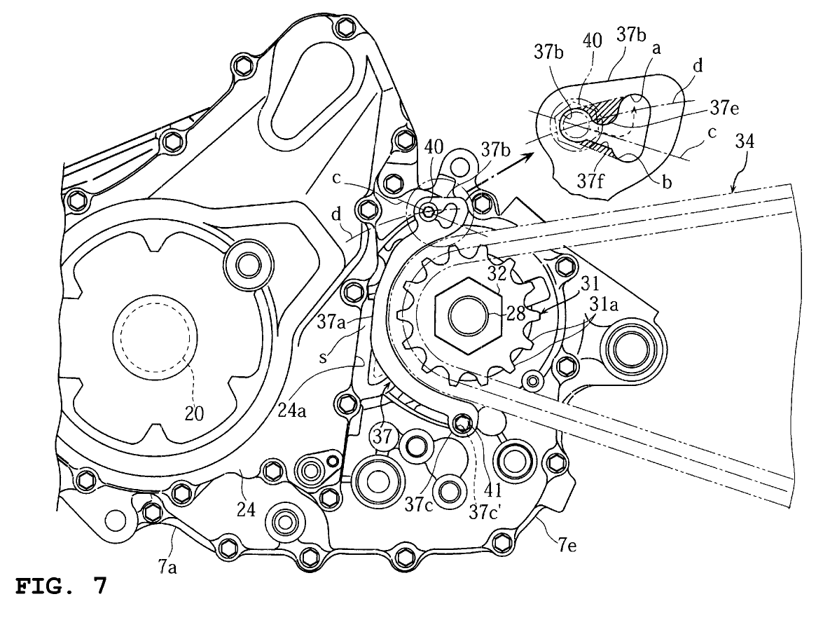

Further, a guide-side stopper is provided in the chain guide 37, and an engine-side stopper that abuts the guide-side stopper is provided in the transmission case 7e. Specifically, the engine-side stopper is defined by the mounting bolt 40. Further, the guide-side stopper is defined by convex portions 37e, 37f provided on the inner edge of the mounting hole 37b′ which is located rearward of the mounting bolt 40 (the diagonally shaded portions in FIG. 7). The convex portions 37e, 37f are opposed to each other so as to abut the mounting bolt 40, thus regulating the forward and rearward movement of the chain guide 37. Accordingly, when the magnitude of the external force acting on the chain guide 37 is not higher than a prescribed value, such as during normal running, the chain guide 37 does not undergo any deformation. The chain guide 37 is thus endowed with the function of preventing skipping of the transmission chain 34 or detachment from the drive sprocket 31.

When an external force of a magnitude equal to or higher than a prescribed value is exerted on the chain guide 37, the convex portions 37e, 37f undergo deformation, causing the chain guide 37 to move about the lower mounting portion 37c in the direction corresponding to the direction (c) of application of the external force, that is, in the forward direction. More specifically, as the chain guide 37 moves forward, as indicated by the broken line in FIG. 7, the mounting bolt 40 moves relatively within the external force direction portion (b) along the external force direction (c), and then moves relatively to the upper right corner portion shown in the drawing, within the pivotal movement direction portion (a).

Here, the time when an external force of a magnitude equal to or higher than a prescribed value is exerted, refers to the time when a large impact force is exerted on the chain guide 37, such as when a roller 34a of the transmission chain 34 rides over teeth 31a of the drive sprocket 31 or when the transmission chain 34 breaks or becomes dislodged to be caught in between the chain guide 37 and the drive sprocket 31. Further, the amount of protrusion, thickness, and the like of the convex portions 37e, 37f are set such that they undergo deformation due to the external force so as to allow the relative movement of the mounting bolt 40.

According to this preferred embodiment, the mounting hole 37b′ of the upper mounting portion 37b of the chain guide 37 preferably have an elongate hole configuration that permits pivotal movement about the lower mounting portion 37c, the upper mounting portion 37b and the lower mounting portion 37c are fixed to the boss portions 7f, 7f of the transmission case 7e with the mounting bolts 40, 41, respectively, and the convex portions 37e, 37f that abut the mounting bolt 40 are provided in the inner edge of the upper mounting hole 37b′. Accordingly, when an external force of a magnitude equal to or higher than a prescribed value acts on the chain guide 37, the convex portions 37e, 37f undergo deformation, causing the chain guide 37 to move forwards. When, for example, a thrown up stone or the like is wedged in between the transmission chain 34 and the drive sprocket 31 and an excessive external force is thus applied to the chain guide 37, the chain guide 37 moves along the elongate hole defined by the mounting hole 37b′. This makes it possible to absorb the external force and prevent breakage or deformation of the boss portion 7f of the transmission case 7e. As a result, even when the large external force described above is exerted on the chain guide 37, the sole replacement of the chain guide 37 suffices, thereby achieving a reduction in repair cost as compared with the case where the entire transmission case 7e has to be replaced.

In this case, even when the convex portions 37e, 37f undergo deformation to cause the chain guide 37 to move forwards, there is no possibility for the upper mounting portion 37b of the chain guide 37 to dislodge from the mounting bolt 40, thereby preventing thrashing and sucking due to the breaking of the chain guide. Further, since the chain guide 37 is retained at the position to which it has moved, the sprocket cover 38 does not move or crack, thereby preventing the drive sprocket 31 from becoming exposed.

In this preferred embodiment, the deformation of the convex portions 37e, 37f of the chain guide 37 allows the movement of the chain guide 37. Accordingly, the external force to be exerted when the chain guide 37 moves can be set in advance by setting the strength, for example, the amount of protrusion or the thickness of the convex portions 37e, 37f.

Further, since the external force is not set by the fastening force of the mounting bolt 40 according to this preferred embodiment, a collar may be fitted to the mounting bolt 40, the collar being brought into engagement with the mounting hole 37b′. In this case, the magnitude of the external force for moving the chain guide 37 forwards can be set with greater accuracy and stability.

Further, according to this preferred embodiment, the mounting hole 37b′ of the upper mounting portion 37b has the external force direction portion (b) formed substantially in conformity with the direction (c) of application of external force, and the pivotal movement direction portion (a) formed substantially in conformity with the circular arc (d) drawn around the lower mounting portion 37c. Accordingly, when a large external force is exerted on the chain guide 37, the deformation of the upper portion of the chain guide 37 and the movement of the chain guide 37 can be absorbed by the external force direction portion (b) and the pivotal movement direction portion (a), respectively, thereby reliably preventing breaking or dislodging of the chain guide 37.

According to this preferred embodiment, the engine-side stopper is defined by the mounting bolt 40, and the guide-side stopper is defined by the convex portions 37e, 37f that are provided in the inner edge of the mounting hole 37b′ and abut the mounting bolt 40, whereby the breaking of the chain guide 37 can be prevented by a simple structure without increasing the number of parts.

It should be noted that while in this preferred embodiment the description is directed to the case where the engine-side stopper is defined by the mounting bolt 40 and the guide-side stopper is defined by the convex portion 37e, 37f provided in the inner edge of the mounting hole 37b′, the structure of the stoppers according to the present invention is not limited to this.

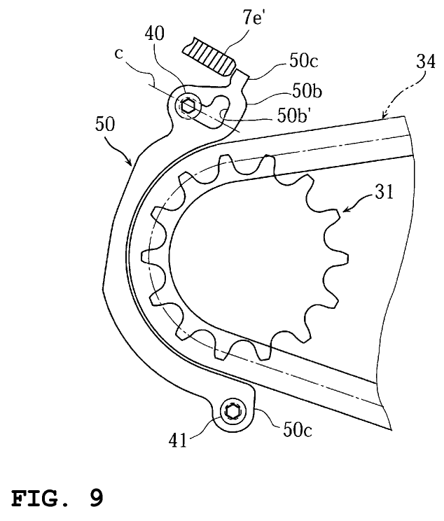

FIG. 9 is a view illustrating the structure of stoppers according to a second preferred embodiment of the present invention.

A chain guide 50 according to the second preferred embodiment has a lower mounting portion 50c and an upper mounting portion 50b, and a mounting hole 50b′ of the upper mounting portion 50b is defined by an elongate hole that permits pivotal movement about the lower mounting portion 50c and is similar to the first preferred embodiment in its basic structure.

A guide-side stopper of the chain guide 50 is defined by a protruding member 50c protruding on the upper end surface of the outer peripheral edge of the upper mounting portion 50b so as to extend in the vertical direction crossing, or more preferably substantially perpendicular to, the direction (c) of application of external force. An engine-side stopper is defined by a protrusion 7e′ provided in the transmission case 7e. The protrusion 7e′ extends substantially parallel to the direction c of application of the external force and adapted to abut the front surface of the protruding member 50c. When an external force of a magnitude equal to or higher than a prescribed value is applied, the protruding member 50c undergoes deformation to be brought out of abutment with the protrusion 7e′, whereby the chain guide 50 moves forwards.

It should be noted that the protruding member 50c can also be provided in the inner peripheral edge of the chain guide 50. In this case as well, the protruding member is arranged so as to extend in the direction crossing, more preferably substantially perpendicular to, the direction (c) of application of external force.

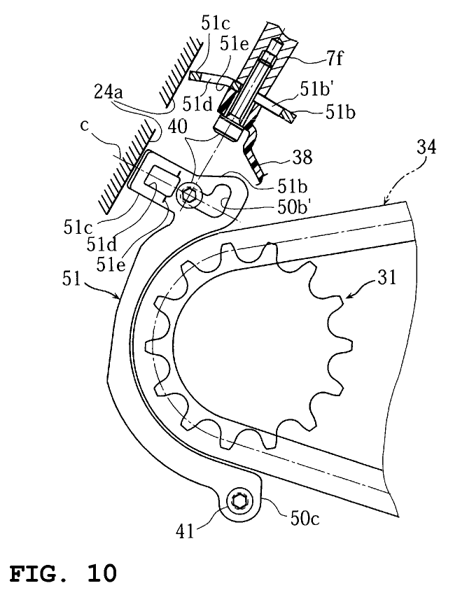

FIG. 10 is a view illustrating the structure of stoppers according to a third preferred embodiment of the present invention.

A guide-side stopper of the chain guide 51 according to the third preferred embodiment is defined by a protruding member 51c protruding on an upper mounting portion 51b of the chain guide 51. The protruding member 51c extends in the direction (c) of application of the external force. Further, a hole 51d that induces deformation or breakage, and a bent portion 51e are provided in the protruding member 51c. An engine-side stopper is defined by the vertical rear wall 24a of the crankcase cover 24 against which the protruding member 51c abuts. When an external force of a magnitude equal to or higher than a prescribed value is exerted, the protruding member 51c undergoes deformation to be brought out of abutment with the vertical rear wall 24a, whereby the chain guide 51 moves forwards. It should be noted that symbol 51b′ denotes a mounting hole having an elongate hole configuration, and symbol 51c denotes a lower mounting portion.

According to the second and third preferred embodiments as well, the breaking of the chain guide can be prevented by a simple structure without increasing the number of parts, whereby the same effect as that of the first preferred embodiment can be attained.

Further, while in each of the above-described preferred embodiments, the description is directed to the example of an all-terrain vehicle, the present invention is also applicable to such vehicles as a motorcycle, a compact tractor, and a golf car. In essence, the present invention is applicable to any type of vehicle in which engine power is transmitted to a driven sprocket via a transmission chain wound around a drive sprocket.

While the present invention has been described with respect to preferred embodiments thereof, it will be apparent to those skilled in the art that the disclosed invention may be modified in numerous ways and may assume many embodiments other than those specifically set out and described above. In addition, various features of the preferred embodiments described above can be combined as desired. Accordingly, it is intended by the appended claims to cover all modifications of the present invention that fall within the true spirit and scope of the present invention.

What is claimed is:

1. A vehicle comprising:
a drive sprocket mounted to an output shaft of an engine;
a driven sprocket mounted to an axle of a drive wheel;
a transmission chain arranged to couple the driven sprocket and the drive sprocket to each other; and
a chain guide arranged on a side of the drive sprocket opposite to the driven sprocket; wherein
the chain guide has a lower mounting portion and an upper mounting portion that are mounted to the engine by a mounting member;
the upper mounting portion has an elongate mounting hole through which the mounting member passes;
a guide-side stopper provided in the chain guide and an engine-side stopper provided in the engine abut each other; and
when an external force of a magnitude equal to or higher than a prescribed value is exerted on the chain guide, the guide-side stopper undergoes deformation, causing the chain guide to move in a direction corresponding to a direction of application of the external force.

2. The vehicle according to claim 1, wherein the chain guide is capable of pivotal movement about the lower mounting portion, and the mounting hole of the upper mounting portion has an external force direction portion that substantially conforms with the direction of application of the external force, and a pivotal movement direction portion that substantially conforms with a circular arc drawn around the lower mounting portion.

3. The vehicle according to claim 1, wherein the guide-side stopper and the engine-side stopper are disposed near the upper mounting portion.

4. The vehicle according to claim 3, wherein the engine-side stopper is defined by the mounting member, the guide-side member is defined by a convex portion protruding on an inner edge of the mounting hole located rearward of the mounting member so as to abut the mounting member to restrict movement of the chain guide, and when the external force of the magnitude equal to or higher than the prescribed value is exerted, the convex portion undergoes deformation to cause the chain guide to move.

5. The vehicle according to claim 3, wherein the guide-side stopper is defined by a protruding member protruding near the mounting hole of the chain guide so as to extend in a direction crossing the direction of application of the external force, the engine-side stopper is defined by a protrusion arranged so as to abut the protruding member, and when the external force of the magnitude equal to or higher than the prescribed value is exerted, the protruding member undergoes deformation to be brought out of abutment with the protrusion, causing the chain guide to move.

6. The vehicle according to claim 3, wherein the guide-side stopper is defined by a protruding member protruding near the mounting hole of the chain guide so as to extend substantially in the direction of application of the external force, the engine-side stopper is defined by an outer wall of the engine with which the protruding member abuts, and when the external force of the magnitude equal to or higher than the prescribed value is exerted, the protruding member undergoes deformation to be brought out of abutment with the outer wall, causing the chain guide to move.

7. The vehicle according to claim 1, wherein the chain guide is made of sheet metal.

8. The vehicle according to claim 1, further comprising a sprocket cover made of resin and arranged to cover the drive sprocket.

9. The vehicle according to claim 1, wherein the chain guide includes a substantially arcuate guide plate portion arranged so as to surround the front half portion of the drive sprocket, and the upper and lower mounting portions are integral at the upper and lower ends of the guide plate portion, respectively.

10. The vehicle according to claim 1, further comprising a transmission case and upper and lower mounting boss portions integrally arranged on the upper side of the transmission case at portions corresponding to the upper and lower mounting portions.

11. The vehicle according to claim 10, further comprising a sprocket cover arranged to cover the drive sprocket, wherein the sprocket cover and the chain guide are fastened onto the transmission case together.

12. The vehicle according to claim 10, wherein the engine-side stopper is provided in the transmission case.

13. The vehicle according to claim 1, wherein the engine-side stopper is defined by a mounting bolt.

14. The vehicle according to claim 1, wherein the guide-side stopper is defined by convex portions of the mounting hole arranged to regulate forward and rearward movement of the chain guide.

15. The vehicle according to claim 1, wherein the mounting hole is arranged to permit pivotal movement of the chain guide about the lower mounting portion.

16. The vehicle according to claim 1, wherein the chain guide includes convex portions arranged to be deformed so as to allow movement of the chain guide.
